(19) United States
(12) Patent Application Publication
(10) Pub. No.: US 2025/0103713 A1
(43) Pub. Date: Mar. 27, 2025

(54) SECURITY MONITORING DEVICE, SECURITY MONITORING METHOD, AND RECORDING MEDIUM

(71) Applicant: Panasonic Intellectual Property Management Co., Ltd., Osaka (JP)

(72) Inventors: Tatsumi OBA, Chiba (JP); Hiroyuki OKADA, Osaka (JP)

(73) Assignee: Panasonic Intellectual Property Management Co., Ltd., Osaka (JP)

(21) Appl. No.: 18/972,449

(22) Filed: Dec. 6, 2024

Related U.S. Application Data
(63) Continuation of application No. PCT/JP2023/022560, filed on Jun. 19, 2023.

(30) Foreign Application Priority Data
Jul. 5, 2022 (JP) 2022-108632

(51) Int. Cl. G06F 21/56

(52) U.S. Cl. CPC G06F 21/56; G06F 2221/034

(57) ABSTRACT

A security monitoring device according to one aspect of the present disclosure includes: a receiver that receives a first alert generated by a first security product detecting a threat and a second alert generated by a second security product detecting a threat, the second security product being different from the first security product; a similarity calculator that calculates a similarity between the first alert and the second alert; and a first determiner that determines whether the first alert and the second alert are alerts generated by detecting a same threat, based on the similarity between the first alert and the second alert.

### CROSS REFERENCE TO RELATED APPLICATIONS

This is a continuation application of PCT International Application No. PCT/JP2023/022560 filed on Jun. 19, 2023, designating the United States of America, which is based on and claims priority of Japanese Patent Application No. 2022-108632 filed on Jul. 5, 2022. The entire disclosures of the above-identified applications, including the specifications, drawings and claims are incorporated herein by reference in their entirety.

### FIELD

The present disclosure relates to a technique for aggregating alerts generated from security products.

### BACKGROUND

In recent years, almost all of intrusion detection systems (IDSs) for detecting security attacks are so-called signature-based IDSs which determine whether the observed data stream includes a specific pattern.

Unfortunately, as malware variants are more easily created and targeted attack is more sophisticated, the percentage of attacks that cannot be captured by the signature-based IDSs has been increasing. Accordingly, also at the security monitoring side, different countermeasures are being demanded.

One of the countermeasures is a software group called user and entity behavior analytics (UEBA).

Unlike the signature-based IDS, UEBA has attack detection models that widely capture the features of frequently used attack methods. Based on input log data, UEBA performs detection using each attack detection model. Each attack detection model performs detection not only by checking the pattern in single data item as the signature-based IDS checks, but also by determining whether multiple data items during a certain period satisfy a specific condition.

By its nature, the attack detection model of UEBA has a different threat-detection range or condition depending on the UEBA product. For this reason, a system that uses multiple UEBAs to detect a wider range of threats with high accuracy would be employed in the future. In doing so, when multiple UEBA products detect the same threat to generate their respective alerts, the efficiency of analysis can be enhanced by aggregating and analyzing these alerts.

PTL 1 discloses the configuration that extracts the associated alerts generated from the same security product using the technique for aggregating the same threats detected by the security product.

### CITATION LIST

### Patent Literature

PTL 1: Japanese Patent No. 6515048

### Non Patent Literature

NPL 1: Alec Radford, et al., “Improving Language Understanding by Generative Pre-Training”, Internet (https://s3-us-west-2.amazonaws.com/openai-assets/research-covers/language-unsupervised/language_understanding_paper.pdf)

### SUMMARY

### Technical Problem

However, by UEBA's nature, when multiple UEBAs generate alerts individually, it is particularly difficult to determine whether each of the alerts has been generated by detecting the same threat.

The configuration disclosed in PTL 1 can extract the associated alerts generated from the same security product, but cannot determine whether multiple security products have generated their respective alerts by detecting the same threat.

In view of this, the present disclosure provides a security monitoring device or the like that, when multiple security products generate their respective alerts, can determine whether these alerts have been generated by detecting the same threat.

### Solution to Problem

A security monitoring device according to one aspect of the present disclosure includes: a receiver that receives a first alert generated by a first security product detecting a threat and a second alert generated by a second security product detecting a threat, the second security product being different from the first security product; a similarity calculator that calculates a similarity between the first alert and the second alert; and a first determiner that determines whether the first alert and the second alert are alerts generated by detecting a same threat, based on the similarity between the first alert and the second alert.

A security monitoring method according to one aspect of the present disclosure includes: receiving a first alert generated by a first security product detecting a threat and a second alert generated by a second security product detecting a threat, the second security product being different from the first security product; calculating a similarity between the first alert and the second alert; and determining whether the first alert and the second alert are alerts generated by detecting a same threat, based on the similarity between the first alert and the second alert.

A recording medium according to one aspect of the present disclosure is a non-transitory computer-readable recording medium storing a program for causing a computer to execute the security monitoring method described above.

### Advantageous Effects

With the security monitoring device according to one aspect of the present disclosure or the like, it is possible to determine whether the alerts generated by multiple security products are alerts generated by detecting the same threat.

### BRIEF DESCRIPTION OF DRAWINGS

These and other advantages and features will become apparent from the following description thereof taken in conjunction with the accompanying Drawings, by way of non-limiting examples of embodiments disclosed herein.

FIG. 1 is a block diagram illustrating an example of the configuration of a security system according to an embodiment.

FIG. 2 is a block diagram illustrating an example of the configuration of a same-threat-alert identifying unit according to the embodiment.

FIG. 3A is a block diagram illustrating an example of another configuration of the same-threat-alert identifying unit according to the embodiment.

FIG. 3B is a block diagram illustrating an example of yet another configuration of the same-threat-alert identifying unit according to the embodiment.

FIG. 4 is a flow chart illustrating a same-threat-alert determination process according to the embodiment.

FIG. 5 is a flow chart illustrating an IDF learning process according to the embodiment.

FIG. 6 is a flow chart illustrating a similarity calculation process using TF-IDF according to the embodiment.

FIG. 7 is a flow chart illustrating a similarity calculation process using words of interest according to the embodiment.

FIG. 8 is a diagram illustrating an example of a word-of-interest list according to the embodiment.

FIG. 9 is a flow chart illustrating an attack-classification-model training process according to the embodiment.

FIG. 10 is a diagram illustrating an example of cyberattack classification categories according to the embodiment.

FIG. 11 is a diagram illustrating an example of threat intelligence information according to the embodiment.

FIG. 12 is a flow chart illustrating a similarity calculation process using the attack classification model according to the embodiment.

FIG. 13 is a diagram for explaining calculation of an attack vector according to the embodiment.

FIG. 14 is a flow chart illustrating a feature extraction process using attack detection information on previous attacks according to the embodiment.

FIG. 15A is a diagram for explaining an example of the attack detection information according to the embodiment.

FIG. 15B is a diagram for explaining an example of alert occurrence time in the attack detection information according to the embodiment.

FIG. 16 is a flow chart illustrating a similarity calculation process using a feature according to the embodiment.

FIG. 17 is a diagram for explaining a specific example of calculating, using a large language model, a similarity between detection model descriptions used by security products, according to the embodiment.

### DESCRIPTION OF EMBODIMENT

(Circumstances Leading to an Aspect according to the Present Disclosure)

With the development of functions of evading malware detections and the proliferation of many malware variants in recent years, many threats are missed only by the signature-based IDS, and thus security products using UEBA or the like that perform detection by defining threat behaviors are being employed in many cases.

UEBA includes a machine learning model (detection model) which has a mechanism that detects threats by learning the normal behavior of each device to be monitored and quantifying the abnormal behavior. Accordingly, there is variation in the threats detected by the security products.

The fact that there is variation in the performance of security products means that introduction of multiple security products each using UEBA (multiple UEBA products) can expand the range of detectable threats and enhance the reliability of detected threats. In particular, when multiple UEBA products detect the same threat, it can be determined with the high reliability that the threat is occurring.

However, there is a difference in the input or output specifications of multiple security products. Accordingly, it is impossible to easily determine whether the alerts have been generated by detecting the same threat.

Therefore, the inventors of the present application have conducted studies hard to solve this problem. Finally, the inventors of the present application found a device or the like that, for example, when the multiple security products each including UEBA generate their respective alerts, can determine whether the alerts have been generated by detecting the same threat. In particular, the inventors of the present application found that a similarity among descriptions of detection models used by the security products to detect threats, which are displayed (outputted) when the security products generate their respective alerts, a similarity among previous detection states of the detection models, and/or the like can be used to determine whether the alerts have been generated by detecting the same threat.

For example, each security product may use different wording for a word with the same meaning in the description of the detection model. Alternatively, even when the text structures of the whole detection model descriptions are similar, there may be a detection model that is trying to detect a distinctly different attack (threat). Accordingly, when a similarity among the detection models is determined based on the fact that the detection model descriptions are similar, a similarity among the descriptions calculated using a general language model does not necessarily correspond to a similarity among threats to be detected by the security products.

In view of this, the present disclosure provides a security monitoring device or the like to solve these problems.

A security monitoring device according to one aspect of the present disclosure includes: a receiver that receives a first alert generated by a first security product detecting a threat and a second alert generated by a second security product detecting a threat, the second security product being different from the first security product; a similarity calculator that calculates a similarity between the first alert and the second alert; and a first determiner that determines whether the first alert and the second alert are alerts generated by detecting a same threat, based on the similarity between the first alert and the second alert.

According to the security monitoring device described above, when security products generate their respective alerts, possible alerts that the security products have generated by detecting the same threat can be aggregated with high reliability. Accordingly, it is possible to efficiently analyze the same threat.

Hereinafter, the specific example of a security monitoring device and a security monitoring method according to one aspect of the present disclosure is described with reference to the drawings. The embodiment described here is one specific example of the present disclosure. Accordingly, the numerical values, shapes, structural elements, the arrangement and connection form of the structural elements, steps, the processing order of the steps, etc. shown in the following embodiment are mere examples, and thus are not intended to limit the present disclosure. Among the structural elements described in the following embodiment, structural elements not recited in any one of the independent claims are optional. Moreover, each of the drawings is a schematic diagram, and thus is not always illustrated precisely.

### Embodiment

The following describes a security monitoring device and a security monitoring method according to an embodiment. The security monitoring device and the security monitoring method according to the embodiment perform a process of determining a similarity between alerts generated by security products. In particular, the security monitoring device and the security monitoring method according to the embodiment determine whether the alerts of the security products have been generated by detecting the same threat.

### (Configuration)

Firstly, the configuration of a same-threat-alert identifying unit, i.e., one example of the security monitoring device, is described.

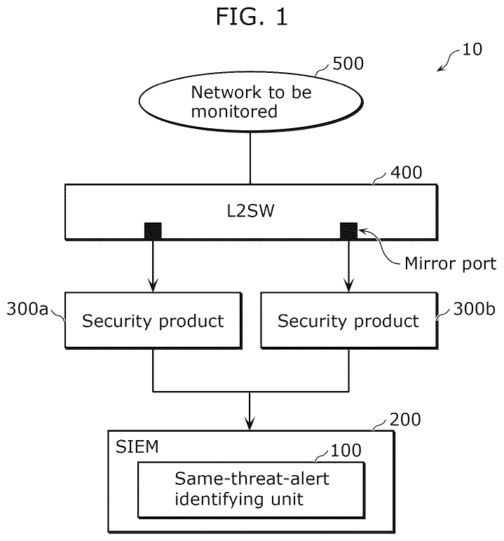

FIG. 1 is a block diagram illustrating an example of the configuration of security system 10 according to the present embodiment.

In FIG. 1, for example, security system 10 includes security information and event management (SIEM) 200, security products 300a and 300b, layer 2 switch (L2SW) 400, and network to be monitored 500.

L2SW 400 is an apparatus with a network relay function, and includes mirror ports.

Network to be monitored 500 is a network monitored by security products 300a and 300b. Network to be monitored 500 is connected to L2SW 400. Frames (log data) flowing in network to be monitored 500 are transmitted to security products 300a and 300b via L2SW 400.

Security products 300a and 300b are each a UEBA product that detects threats by defining threat behaviors. Security products 300a and 300b are respectively connected to the mirror ports of L2SW 400, and obtain the log data outputted from network to be monitored 500 via L2SW 400.

It is to be noted that the present embodiment is described for the case where security system 10 includes two security products, but this case is merely one example. Security system 10 may include three or more security products.

SIEM 200 is communicably connected to security products 300a and 300b, and is a system that obtains alerts outputted from security products 300a and 300b and manages and/or analyzes the alerts and threats. SIEM 200 includes same-threat-alert identifying unit 100.

Each of security products 300a and 300b performs detection of attacks (threats) using the obtained log data, and outputs an alert to SIEM 200 when an attack is detected.

SIEM 200 inputs the obtained alerts to same-threat-alert identifying unit 100, and uses the output results for analysis.

Next, the configuration of the security monitoring device according to the embodiment is described.

### Example 1

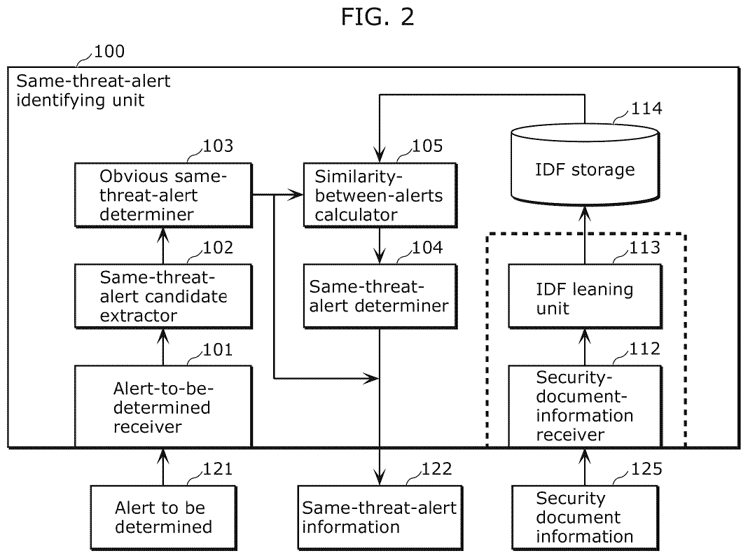

FIG. 2 is a block diagram illustrating an example of the configuration of same-threat-alert identifying unit 100 according to the present embodiment.

In FIG. 2, same-threat-alert identifying unit 100 includes alert-to-be-determined receiver 101, same-threat-alert candidate extractor 102, obvious same-threat-alert determiner 103, similarity-between-alerts calculator 105, same-threat-alert determiner 104, security-document-information receiver 112, inverse document frequency (IDF) leaning unit 113, and IDF storage 114. Each processing unit such as alert-to-be-determined receiver 101, same-threat-alert candidate extractor 102, obvious same-threat-alert determiner 103, similarity-between-alerts calculator 105, same-threat-alert determiner 104, security-document-information receiver 112, and IDF leaning unit 113 is implemented by, for example, a processor and a memory such as a semiconductor memory storing a control program to be executed by the processor. The storage device such as IDF storage 114 is implemented by, for example, a hard disk drive (HDD).

Moreover, same-threat-alert identifying unit 100 is one example of the security monitoring device. Moreover, alert-to-be-determined receiver 101 is one example of the receiver. Same-threat-alert candidate extractor 102 is one example of the extractor. Moreover, obvious same-threat-alert determiner 103 is one example of second the determiner. Moreover, same-threat-alert determiner 104 is one example of the first determiner. Moreover, similarity-between-alerts calculator 105 is one example of the similarity calculator.

Alert-to-be-determined receiver 101 receives alert to be determined 121 (also referred to just as an alert) from security product 300a or security product 300b. Alert-to-be-determined receiver 101 notifies same-threat-alert candidate extractor 102 of the received alert.

Alert to be determined 121 is an alert (information) about the threat detected by security product 300a or 300b. For example, the alert includes an alert occurrence time, the internet protocol (IP) address of a device detected as threat (e.g., the attacked device), and a detection model description for describing, by the alert, what event (threat) has been detected. The detection model is included in each of security products 300a and 300b, and refers to a learning model for detecting threads. The detection model description refers to a text for describing the threat detected by the security product. In particular, the detection model description refers to a text for describing the content of a threat when each of security products 300a and 300b detects the threat using the detection model. The detection model description is, for example, “A device is repeatedly communicating with an external location with encrypted channel. There is a risk of the data being transmitted.”

Same-threat-alert candidate extractor 102 narrows down the notified alerts to extract candidate alerts whose sameness (more specifically, whether each alert is an alert generated by detecting the same threat) needs to be determined.

For example, the condition of a candidate for the alert with the sameness, i.e., the alert generated by detecting the same threat (also referred to as the same-threat alert), is that a difference in the occurrence time between the alert notified by security product 300a and the alert notified by security product 300b is within 60 minutes and/or that the IP address of the device detected as a threat is the same. For example, same-threat-alert candidate extractor 102 extracts an alert satisfying such a condition as a candidate alert (more specifically, a candidate for the same-threat alert). The condition of narrowing down candidate alerts is defined in advance.

Same-threat-alert candidate extractor 102 extracts a candidate for the same-threat alert according to the condition. This condition is one example of the predetermined condition. As described above, same-threat-alert candidate extractor 102 extracts a candidate alert from among alerts received by alert-to-be-determined receiver 101 based on the predetermined condition.

Same-threat-alert candidate extractor 102 notifies obvious same-threat-alert determiner 103 of the notified alert and the alert extracted as a candidate for the same-threat alert. It is to be noted that when there are three or more security products and when the number of the notified alerts is plural and the number of the alerts extracted as candidates for the same-threat alert is plural, same-threat-alert candidate extractor 102 notifies obvious same-threat-alert determiner 103 of alerts including the notified alerts and the alerts extracted as candidates for the same-threat alert, as a group of alerts.

Obvious same-threat-alert determiner 103 determines whether the notified alert and the alert extracted as a candidate for the same-threat alert are obvious same-threat alerts.

The obvious same-threat alert refers to an alert to be outputted when the obviously same threat is detected, e.g., when the detection models of all the security products (security product 300a and security product 300b in the present embodiment) that have detected threats (attacks) are dedicated to detect a specific malware. Information (product information) indicating that, for example, such a malware is detected, i.e., what threat the detection model for detecting, by the security product, threats detects, may be stored in advance in a memory included in same-threat-alert identifying unit 100, or may be transmitted from security products 300a and 300b to same-threat-alert identifying unit 100. As described above, obvious same-threat-alert determiner 103 determines whether each alert has been outputted by detecting the same threat, based on the product information on security products 300a and 300b.

When it is determined that the notified alert and the alert extracted as a candidate for the same-threat alert are obvious same-threat alerts, obvious same-threat-alert determiner 103 outputs same-threat-alert information 122. Same-threat-alert information 122 indicates that each alert is an alert generated by detecting the same threat. For example, when it is determined that the alert (alert ID: a-0010) outputted (generated) by security product 300a and the alert (alert ID: b-0008) outputted (generated) by security product 300b are the same, obvious same-threat-alert determiner 103 outputs, as same-threat-alert information 122, information represented in list form such as (a-0010, b-0008). For example, obvious same-threat-alert determiner 103 outputs such same-threat-alert information 122 to a processing unit in SIEM 200 that analyzes threats.

When it is not determined that the notified alert and the alert extracted as a candidate for the same-threat alert are obvious same-threat alerts, obvious same-threat-alert determiner 103 notifies similarity-between-alerts calculator 105 of the notified alert and the alert extracted as a candidate for the same-threat alert.

Similarity-between-alerts calculator 105 calculates a similarity between the notified alerts. In particular, similarity-between-alerts calculator 105 calculates the similarity between the alerts which are the candidate alerts extracted by same-threat-alert candidate extractor 102. More specifically, similarity-between-alerts calculator 105 calculates the similarity between the alerts which are the candidate alerts extracted by same-threat-alert candidate extractor 102 and are determined not to be obvious same-threat alerts by obvious same-threat-alert determiner 103. In the present example, similarity-between-alerts calculator 105 uses the detection model description of the notified alert and the detection model description of the alert extracted as a candidate for the same-threat alert to calculate the similarity between the alerts.

More specifically, similarity-between-alerts calculator 105 extracts words from the detection model description of each alert, and also extracts the IDF values associated with the respective extracted words, which are stored in IDF storage 114.

Similarity-between-alerts calculator 105 calculates a term frequency-inverse document frequency (TF-IDF) vector using the extracted IDF values, for the detection model description of each alert (more specifically, the words extracted from the detection model description). The document information indicating a document on security (security document information) is used to extract the IDF values. For example, similarity-between-alerts calculator 105 calculates the similarity between the alerts based on TF-IDF vectors of their respective detection model descriptions, each of which is calculated using the IDF values of words included in the document information.

Similarity-between-alerts calculator 105 calculates a cosine similarity between the TF-IDF vectors using the TF-IDF vector for the detection model description of each alert.

Similarity-between-alerts calculator 105 notifies same-threat-alert determiner 104 of the calculated cosine similarity.

Based on the similarity between the alerts, same-threat-alert determiner 104 determines whether each alert is an alert generated by detecting the same threat. In the present example, same-threat-alert determiner 104 determines whether the notified alert and the alert extracted as a candidate for the same-threat alert are same-threat alerts, by comparing the notified cosine similarity to the predefined threshold. When the notified cosine similarity exceeds the predefined threshold, same-threat-alert determiner 104 determines that each alert is the same-threat alert and outputs same-threat-alert information 122. In contrast, when the notified cosine similarity does not exceed the threshold, same-threat-alert determiner 104 determines each similarity is not the same-threat alert. For example, when the notified cosine similarity does not exceed the threshold, same-threat-alert determiner 104 does not output same-threat-alert information 122. For example, same-threat-alert determiner 104 outputs same-threat-alert information 122 to a processing unit that analyzes the threat and included in SIEM 200. With this, the threat is analyzed by the processing unit based on same-threat-alert information 122. For example, the analysis result is transmitted to a computer or the like used by an administrator, and the administrator takes countermeasures against the threat based on the analysis results.

IDF storage 114 stores IDF values which are results of learning security document information 125 and learning IDFs of words included in security document information 125.

The IDF learning may be performed in advance in same-threat-alert identifying unit 100, may be performed by same-threat-alert identifying unit 100 when the similarity between the alerts is calculated, or need not be performed in same-threat-alert identifying unit 100. In the present embodiment, the case where the learning is performed in advance in same-threat-alert identifying unit 100 is described.

Security-document-information receiver 112 receives security document information 125. Security document information 125 indicates the text of security blogs published on the Internet or the like. Security-document-information receiver 112 notifies IDF leaning unit 113 of received security document information 125.

IDF leaning unit 113 extracts words from received security document information 125, performs clustering on the extracted words, and maps the words to cluster IDs. IDF leaning unit 113 learns IDF using the cluster ID of each word in received security document information 125 to obtain the IDF values. IDF leaning unit 113 stores the IDF values obtained by learning, in IDF storage 114.

### Example 2

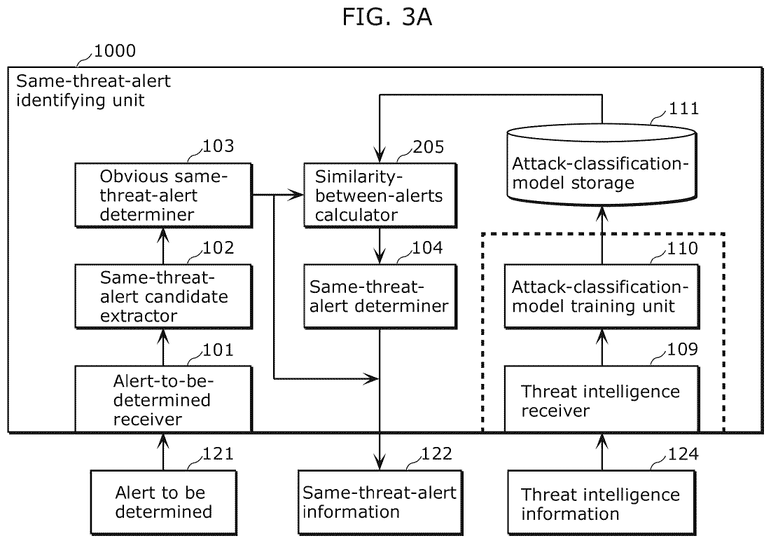

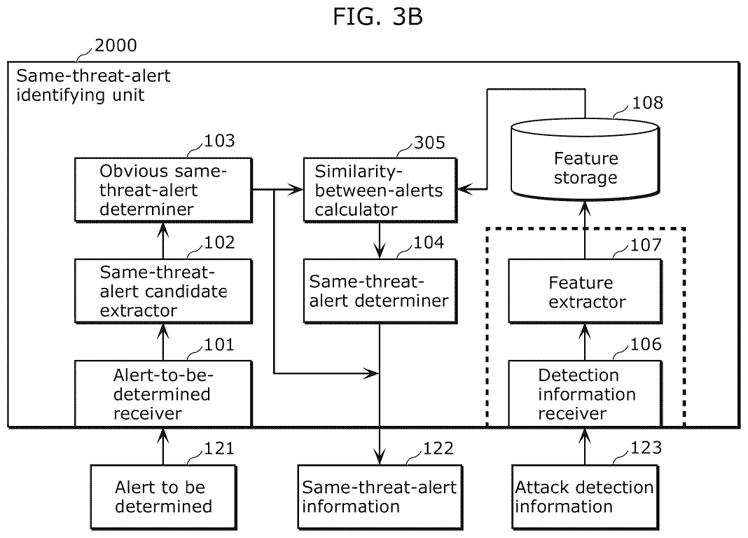

FIG. 3A is a block diagram illustrating an example of another configuration of the same-threat-alert identifying unit according to the present embodiment. It is to be noted that the same components as same-threat-alert identifying unit 100 are assigned to the same reference numerals, and their explanations are omitted.

In FIG. 3A, same-threat-alert identifying unit 1000 includes alert-to-be-determined receiver 101, same-threat-alert candidate extractor 102, obvious same-threat-alert determiner 103, same-threat-alert determiner 104, similarity-between-alerts calculator 205, threat intelligence receiver 109, attack-classification-model training unit 110, and attack-classification-model storage 111. Each of the processing units such as similarity-between-alerts calculator 205, threat intelligence receiver 109, and attack-classification-model training unit 110 is implemented by, for example, a processor and a memory such as a semiconductor memory storing a control program to be executed by the processor. Attack-classification-model storage 111 is implemented by, for example, a HDD.

Moreover, same-threat-alert identifying unit 1000 is one example of the security monitoring device. Moreover, similarity-between-alerts calculator 205 is one example of the similarity calculator.

Similarity-between-alerts calculator 205 calculates the similarity between the notified alert and the alert extracted as a candidate for the same-threat alert, using the attack classification model stored in attack-classification-model storage 111.

Attack-classification-model storage 111 stores the attack classification model trained using threat intelligence information 124 including both classification information indicating a cyberattack (threat) classification category (also referred to as an attack classification category) and information in which each attack classification category is associated with a document describing the outline of the attack.

The training of the attack classification model may be performed in advance in same-threat-alert identifying unit 1000, may be performed by same-threat-alert identifying unit 1000 when the similarity between the alerts is calculated, or need not be performed in same-threat-alert identifying unit 1000. In the present embodiment, the case where the training is performed in advance in same-threat-alert identifying unit 1000 is described.

Threat intelligence receiver 109 receives threat intelligence information 124 including both the classification information and the classification content (the outline of the attack). Threat intelligence receiver 109 notifies attack-classification-model training unit 110 of received threat intelligence information 124.

Attack-classification-model training unit 110 trains the attack classification model using received threat intelligence information 124 including both the classification information and the classification content (the outline of the attack).

Attack-classification-model training unit 110 stores the trained attack classification model in attack-classification-model storage 111.

Similarity-between-alerts calculator 205 obtains an attack vector of the detection model description (an attack classification vector) by inputting the detection model description included in each alert into the attack classification model. Similarity-between-alerts calculator 205 calculates the similarity between the alerts based on the obtained attack vectors.

As described above, in present example, the similarity-between-alerts calculator 205 calculates the similarity between the alerts based on their respective attack vectors each indicating matching degrees of threat classification categories, which are calculated using the attack classification model trained using threat intelligence information 124 indicating both the classification information indicating the threat classification category and its classification content. The details of the attack vector are described later.

### Example 3

FIG. 3B is a diagram illustrating an example of yet another configuration of the same-threat-alert identifying unit according to the present embodiment. It is to be noted that the same components as same-threat-alert identifying unit 100 are assigned to the same reference numerals, and their explanations are omitted.

In FIG. 3B, same-threat-alert identifying unit 2000 includes alert-to-be-determined receiver 101, same-threat-alert candidate extractor 102, obvious same-threat-alert determiner 103, same-threat-alert determiner 104, similarity-between-alerts calculator 305, detection information receiver 106, feature extractor 107, and feature storage 108. Each of the processing units such as similarity-between-alerts calculator 305, detection information receiver 106, and feature extractor 107 is implemented by, for example, a processor and a memory such as a semiconductor memory storing a control program to be executed by the processor. The storage device such as feature storage 108 is implemented by, for example, a HDD.

Moreover, same-threat-alert identifying unit 2000 is one example of the security monitoring device. Similarity-between-alerts calculator 305 is one example of the similarity calculator.

Similarity-between-alerts calculator 305 calculates the similarity between the notified alert and the alert extracted as a candidate for the same-threat alert, using the feature stored in feature storage 108.

Feature storage 108 stores the feature of security product 300a and the feature of security product 300b extracted using attack detection information 123 on attacks previously detected by security product 300a and attack detection information 123 on attacks previously detected by security product 300b, respectively.

The extraction of the feature may be performed in advance in same-threat-alert identifying unit 2000, may be performed by same-threat-alert identifying unit 2000 when the similarity between the alerts is calculated, or need not be performed in same-threat-alert identifying unit 2000. In the present embodiment, the case where the extraction is performed in advance in same-threat-alert identifying unit 2000 is described.

Detection information receiver 106 receives attack detection information 123 on attacks previously detected by security product 300a and attack detection information 123 on attacks previously detected by security product 300b, and notifies feature extractor 107 of each attack detection information 123.

Feature extractor 107 extracts the feature of each notified attack detection information 123, and stores the extracted features in feature storage 108.

As described above, similarity-between-alerts calculator 305 calculates the similarity between the alerts using the features extracted using the detection information indicating the previous attack detection results (attack detection information 123) for each of security products 300a and 300b. The details of attack detection information 123 and the feature are described later.

### <Processing Procedure>

Next, the processing procedure of the same-threat-alert identifying unit, i.e., one example of the security monitoring device, is described.

### Example 1

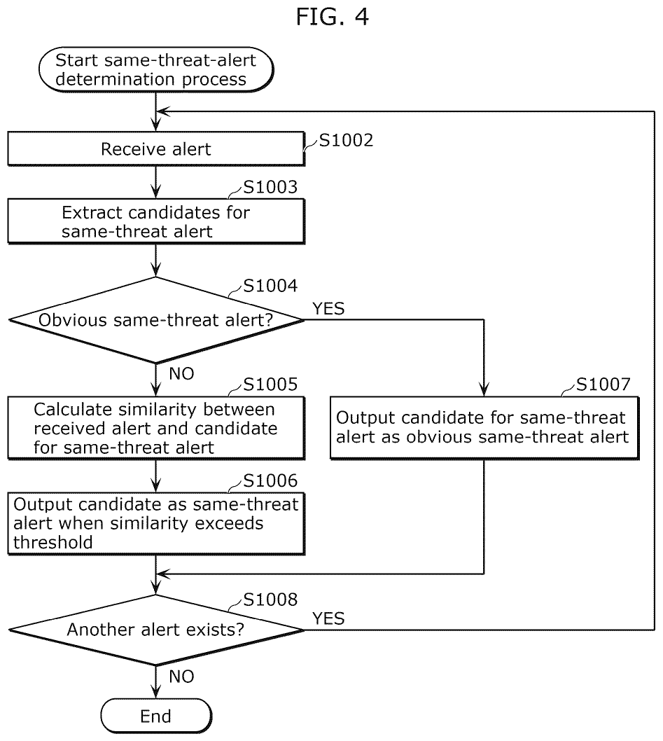

FIG. 4 is a flow chart illustrating a same-threat-alert determination process using same-threat-alert identifying unit 100 according to the embodiment.

Firstly, same-threat-alert identifying unit 100 receives the alert notified from security product 300a or 300b (S1002).

Next, for the received alert, same-threat-alert identifying unit 100 extracts candidates for the alert similar to the currently received alert, i.e., candidates for the same-threat alert, from previously received alerts (S1003).

Next, same-threat-alert identifying unit 100 determines whether there is an obviously similar alert, i.e., an obvious same-threat alert, among the extracted candidate alerts (S1004).

When it is determined that there is an obvious same-threat alert (YES in S1004), same-threat-alert identifying unit 100 extracts a previous alert regarded as being similar to the currently captured (i.e., received) alert, and outputs same-threat-alert information 122 indicating that the extracted previous alert and the received alert are obvious same-threat alerts (S1007).

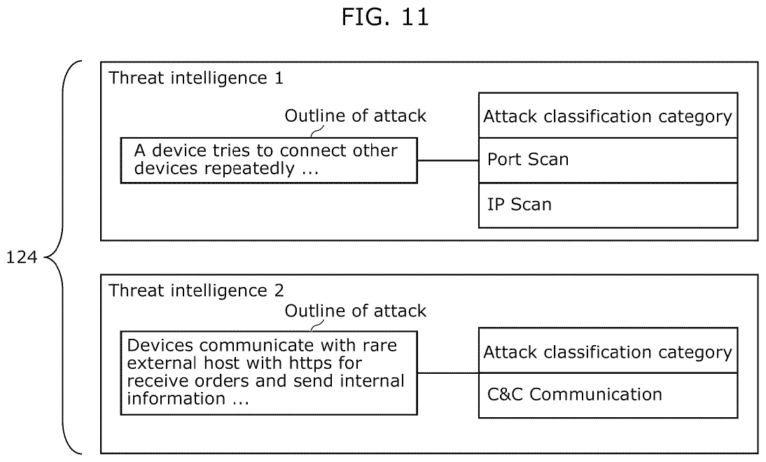

In contrast, when it is determined that there is no obvious same-threat alert (NO in S1004), same-threat-alert identifying unit 100 calculates the similarity between the received alert and a candidate for the same-threat alert (S1005). Same-threat-alert identifying unit 100 uses, for example, a method of calculating a similarity between descriptions using TF-IDF for the similarity calculation. The details are described later using FIG. 11.

Next, when the similarity between the received alert and the candidate for the same-threat alert exceeds the threshold, same-threat-alert identifying unit 100 outputs same-threat-alert information 122 indicating that the received alert and the candidate for the same-threat alert are similar (i.e., the same-threat alert) (S1006). Here, for example, when the similarity between the received alert and the candidate for the same-threat alert does not exceed the threshold, same-threat-alert identifying unit 100 does not output same-threat-alert information 122, and the processing proceeds to Step S1008.

Subsequently to Step S1006 or Step S1007, same-threat-alert identifying unit 100 checks whether another alert not yet determined in the above manner exists among the notified alerts (S1008).

When there is another alert (YES in S1008), same-threat-alert identifying unit 100 performs the process in Step S1002.

In contrast, when there is no another alert (NO in S1008), same-threat-alert identifying unit 100 ends the processing.

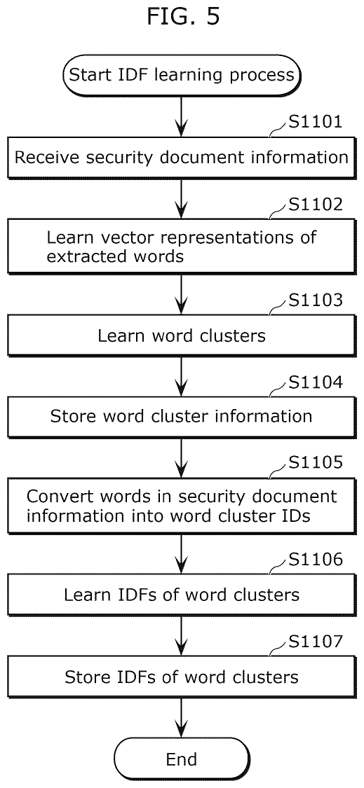

FIG. 5 is a flow chart illustrating an IDF learning process according to the embodiment.

Firstly, security-document-information receiver 112 receives security document information 125 (S1101).

Next, IDF leaning unit 113 extracts words in security document information 125, and learns vector representations using Skipgram for the extracted words (S1102).

Next, IDF leaning unit 113 sets a suitable number of clusters K, and performs clustering using K-means method for a group of the word vectors obtained by learning, to learn the word clusters (S1103). Number of clusters K may be freely determined in advance, and is not particularly limited.

Next, IDF leaning unit 113 stores, in IDF storage 114, word cluster information for mapping the words to cluster IDs which is obtained by learning (S1104).

Next, IDF leaning unit 113 converts each word in security document information 125 into a cluster ID (word cluster ID) using the word cluster information stored in IDF storage 114 (S1105).

Next, IDF leaning unit 113 learns IDF of each word cluster using received whole security document information 125 (S1106). Next, IDF leaning unit 113 stores, in IDF storage 114, the IDFs (more specifically, IDF values) obtained by learning (S1107).

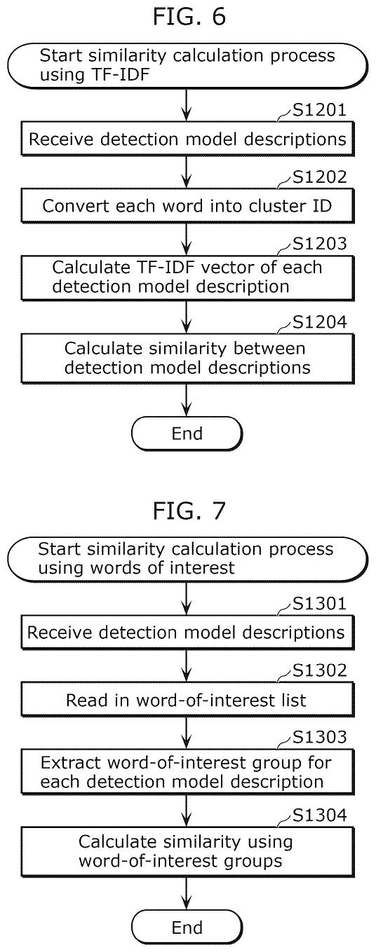

FIG. 6 is a flow chart illustrating a similarity calculation process using TF-IDF, performed by same-threat-alert identifying unit 100 according to the embodiment.

Firstly, similarity-between-alerts calculator 105 receives both the detection model description of the alert notified from security product 300a or 300b and the detection model description of the alert extracted as a candidate for the same-threat alert (S1201).

Next, similarity-between-alerts calculator 105 converts each word in each detection model description into a cluster ID using the word cluster information stored in IDF storage 114 (S1202).

Next, similarity-between-alerts calculator 105 calculates the TF-IDF vector of each detection model description using the IDFs (IDF values) stored in IDF storage 114 (S1203).

Next, similarity-between-alerts calculator 105 calculates the cosine similarity between the TF-IDF vectors for the respective detection model descriptions to calculate the similarity between the detection model descriptions (S1204).

### <Variation 1>

It is to be noted that similarity-between-alerts calculator 105 included in same-threat-alert identifying unit 100 uses the TF-IDF vectors to calculate the similarity between the detection model descriptions, but may use words of interest to calculate the similarity. For example, instead of similarity-between-alerts calculator 105, same-threat-alert identifying unit 100 may include similarity-between-alerts calculator that calculates the similarity using words of interest.

The following describes the case where, instead of the similarity calculation by similarity-between-alerts calculator 105, the similarity calculation is performed using words of interest by the similarity-between-alerts calculator according to Variation 1. The similarity-between-alerts calculator according to Variation 1 is one example of the similarity calculator.

FIG. 7 is a flow chart illustrating a similarity calculation process using words of interest, according to the embodiment.

Firstly, the similarity-between-alerts calculator according to Variation 1 receives both the detection model description of the alert notified from security product 300a or 300b and the detection model description of the alert extracted as a candidate for the same-threat alert (S1301).

Next, the similarity-between-alerts calculator according to Variation 1 reads in a predefined word-of-interest list (S1302).

Here, the word-of-interest list is described.

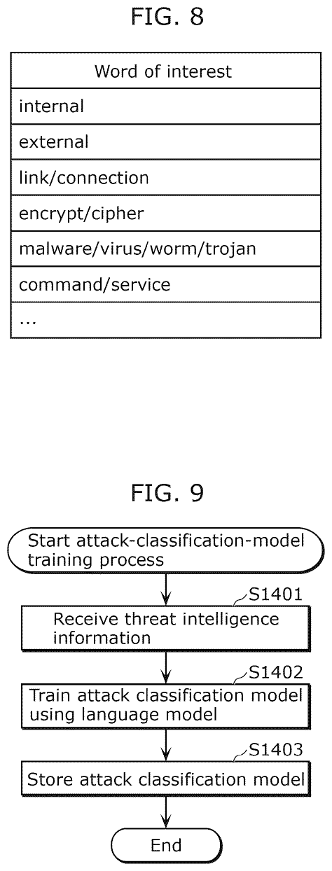

FIG. 8 is a diagram illustrating an example of the word-of-interest list.

The word-of-interest list includes, as the words of interest, listed information of specific words and specific sets of words. In FIG. 8, “internal”, “external”, “link/connection”, “encrypt/cipher”, “malware/virus/worm/trojan”, “command/service”, etc., are listed as words of interest.

It is to be noted that, as shown in FIG. 8, when a word of interest is defined in the form of “∘∘/xx”, this intends a word of interest “∘∘” or a word of interest “x x”.

The explanation goes back to FIG. 7. Next to Step S1303, for each detection model description, the similarity-between-alerts calculator according to Variation 1 extracts a group of words appearing in the detection model description among the words in the word-of-interest list (a word-of-interest group) (S1303). In particular, the similarity-between-alerts calculator according to Variation 1 generates a word-of-interest group including one or more extracted words of interest by extracting, for each detection model description, words of interest included in the detection model description among the words of interest included in the word-of-interest list.

Next, the similarity-between-alerts calculator according to Variation 1 calculates the similarity between the detection model descriptions using the Jaccard coefficient for the word-of-interest groups extracted from their respective detection model descriptions (S1304).

As described above, similarity-between-alerts calculator according to Variation 1 calculates the similarity between the alerts by extracting the words of interest included in each detection model description using the predefined word-of-interest list and by calculating the similarity between the word-of-interest groups, each composed of one or more words of interest, extracted from their respective detection model descriptions.

### Example 2

FIG. 9 is a flow chart illustrating an attack-classification-model training process according to the embodiment. In particular, FIG. 9 is a flow chart illustrating a specific processing procedure of same-threat-alert identifying unit 1000.

Firstly, threat intelligence receiver 109 receives threat intelligence information 124 indicating both classification information indicating a cyberattack classification category (an attack classification category) and its classification content (a document describing its classification (threat intelligence)) (S1401).

Here, the details of threat intelligence information 124 are described.

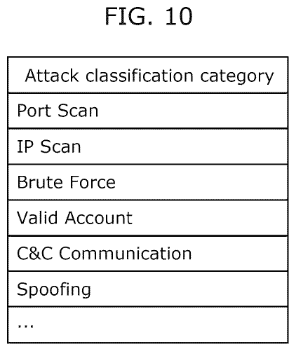

FIG. 10 is a diagram illustrating an example of cyberattack classification categories according to the embodiment.

The attack classification categories are information items into which various attack methods used by attackers are generally classified. For example, ATT&CK (Adversarial Tactics, Techniques, and Common Knowledge) MATRIX published by the MITRE Corporation may be used to generate the attack classification categories. It is to be noted that the attack types in the attack classification categories may be freely determined, and are not particularly limited.

In FIG. 10, “Port Scan”, “IP Scan”, “Brute Force”, “Valid Account”, “C&C Communication”, and “Spoofing” are listed as the attack classification categories.

FIG. 11 is a diagram illustrating an example of threat intelligence information 124 according to the present embodiment.

Threat intelligence information 124 is a group of sets in each which attack of the classification category (classification information) is associated with a text describing the outline of the attack. For example, the associated attack classification category comprises one or more attack classification categories among the attack classification categories included in the attack-classification-category list shown in FIG. 10.

In FIG. 11, threat intelligence information 124 includes threat intelligence 1 and threat intelligence 2. In threat intelligence 1, the outline of the attack indicated by the text “A device tries to connect other devices repeatedly . . . ” and the attack classification categories “Port Scan” and “IP Scan” are associated with each other. In threat intelligence 2, the outline of the attack indicated by the text “Devices communicate with rate external host with https for receive orders and send internal information . . . ” and the attack classification category “C&C Communication” are associated with each other.

The explanation goes back to FIG. 9. Next to Step S1401, attack-classification-model training unit 110 trains the attack classification model using threat intelligence information 124 and a language model such as bidirectional encoder representations from transformers (BERT) (S1402).

Next, attack-classification-model training unit 110 stores the trained attack classification model in attack-classification-model storage 111 (S1403).

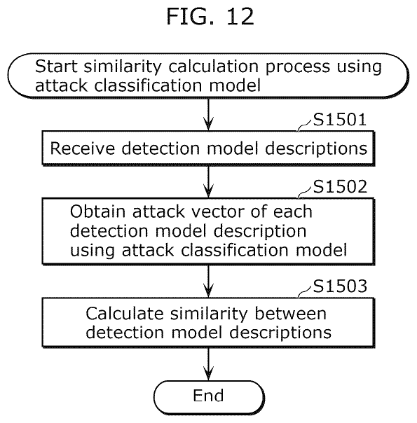

FIG. 12 is a flow chart illustrating a similarity calculation process using the attack classification model, according to the embodiment.

Firstly, similarity-between-alerts calculator 205 receives both the detection model description of the alert notified from security product 300a or 300b and the detection model description of the alert extracted as a candidate for the same-threat alert (S1501).

Next, similarity-between-alerts calculator 205 obtains an attack vector of each detection model description using the attack classification model stored in attack-classification-model storage 111 (S1502).

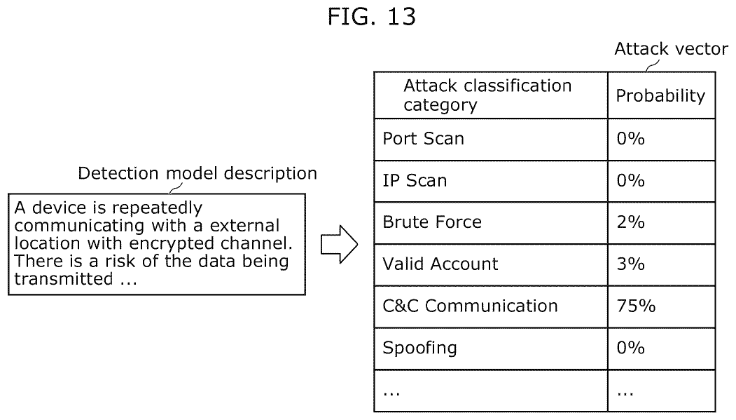

FIG. 13 is a diagram for explaining calculation of the attack vector according to the embodiment.

In FIG. 13, similarity-between-alerts calculator 205 obtains, using the attack classification model, the attack vector of the detection model description “A device is repeatedly communicating with an external location with encrypted channel. There is a risk of the data being transmitted . . . ”. The attack vector is represented by the probabilities for their respective attack classification categories shown in FIG. 10. In the example shown in FIG. 13, the probabilities are calculated from the detection model description, such as probability 0% for attack classification category “Port Scan”, 0% for “IP Scan”, 2% for “Brute Force”, 3% for “Valid Account”, 75% for “C&C Communication”, and 0% for “Spoofing”. Moreover, the attack vector in this example is (0, 0, 2, 3, 75, 0).

The explanation goes back to FIG. 12. Next to Step S1502, similarity-between-alerts calculator 205 calculates the similarity (more specifically, the cosine similarity) between the attack vectors of two compared detection model descriptions (S1503).

### Example 3

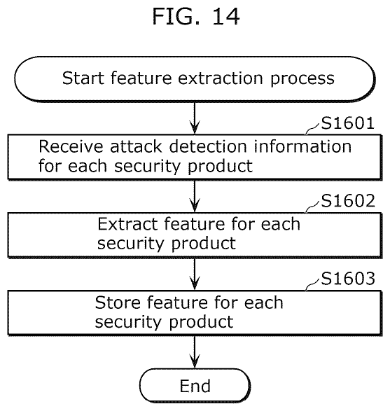

FIG. 14 is a flow chart illustrating a feature extraction process using attack detection information 123 on previous attacks, according to the embodiment. In particular, FIG. 14 is a flow chart illustrating a specific processing procedure of same-threat-alert identifying unit 2000.

Firstly, detection information receiver 106 receives attack detection information 123 on attacks previously detected by security product 300a and attack detection information 123 on attacks previously detected by security product 300b (S1601).

Here, the details of attack detection information 123 are described.

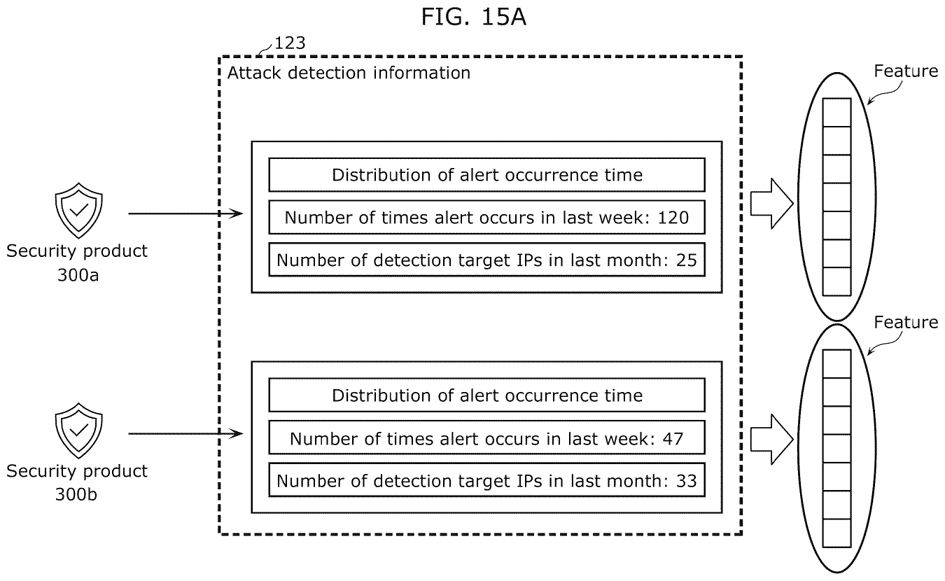

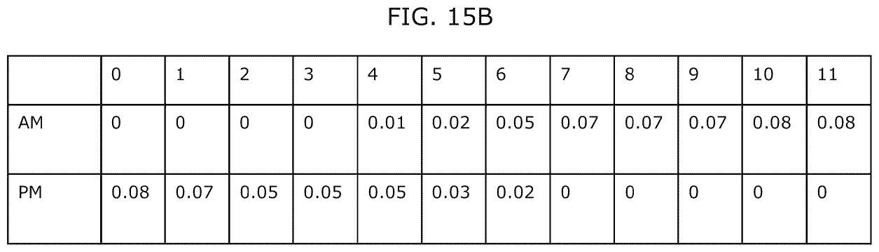

FIG. 15A is a diagram for explaining an example of attack detection information 123 according to the present embodiment.

In FIG. 15A, attack detection information 123 includes the attack detection information on attacks previously detected by security product 300a and the attack detection information on attacks previously detected by security product 300b. Each attack detection information includes at least the distribution of alert occurrence time, the number of times that an alert occurs in the last week, and the number of detection target IPs in the last month. FIG. 15B is a diagram for explaining an example of alert occurrence time in attack detection information 123 according to the embodiment. In particular, FIG. 15B is a diagram illustrating the distribution of alert occurrence time in the attack detection information on attacks previously detected by security product 300a, among information items in attack detection information 123 according to the present embodiment.

In the example shown in FIG. 15B, for example, the distribution of alert occurrence time in the attack detection information on attacks previously detected by security product 300a is “0” for 0 a.m., “0” for 1 a.m., “0” for 2 a.m., “0” for 3 a.m., “0.01” for 4 a.m., “0.02” for 5 a.m., “0.05” for 6 a.m., “0.07” for 7 a.m., “0.07” for 8 a.m., “0.07” for 9 a.m., “0.08” for 10 a.m., “0.08” for 11 a.m., “0.08” for 0 p.m., “0.07” for 1 p.m., “0.05” for 2 p.m., “0.05” for 3 p.m., “0.05” for 4 p.m., “0.03” for 5 p.m., “0.02” for 6 p.m., “0” for 7 p.m., “0” for 8 p.m., “0” for 9 p.m., “0” for 10 p.m., and “0” for 11 p.m.

The explanation goes back to FIG. 15A. In the attack detection information on attacks previously detected by security product 300a, the number of times that an alert occurs in the last week is “120”, and the number of detection target IPs in the last month is “25”.

The explanation goes back to FIG. 14. Next to Step S1601, feature extractor 107 extracts the feature of each attack detection information 123 on previous attacks (S1602). For example, feature extractor 107 extracts, as the feature, the distribution of alert occurrence time, the number of times that an alert occurs in the last week, and the number of detection target IPs in the last month, based on each attack detection information 123.

Next, feature extractor 107 stores the extracted features in feature storage 108 (S1603).

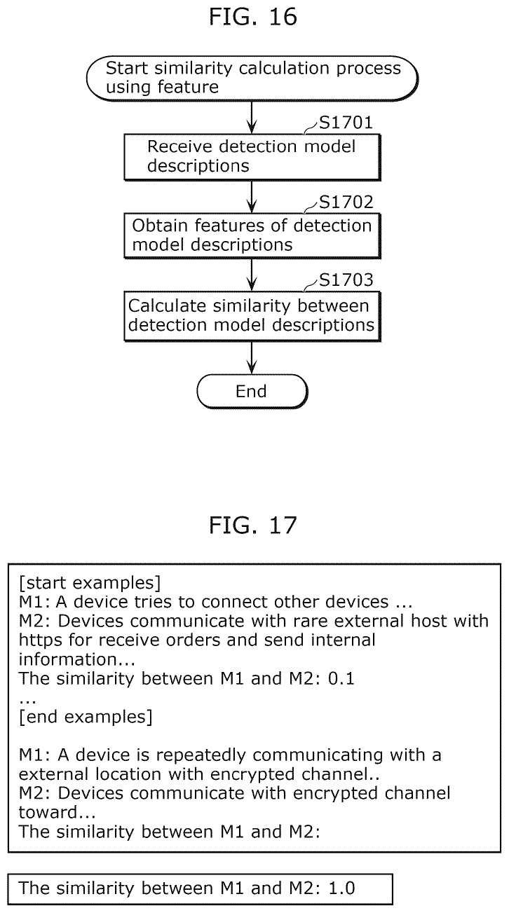

FIG. 16 is a flow chart illustrating a similarity calculation process using the feature, according to the embodiment.

Firstly, similarity-between-alerts calculator 305 receives both the detection model description of the alert notified from security product 300a or 300b and the detection model description of the alert extracted as a candidate for the same-threat alert (S1701).

Next, similarity-between-alerts calculator 305 obtains the feature corresponding to each detection model description from among the features stored in feature storage 108 (S1702).

Next, similarity-between-alerts calculator 305 calculates the similarity between the features of two compared alerts (S1703).

### <Variation 2>

It is to be noted that the method of calculating a similarity is not limited to a similarity calculation method performed by each of similarity-between-alerts calculators 105, 205, and 305, and similarity-between-alerts calculator according to Variation 1.

For example, the similarity-between-alerts calculator may calculate the similarity between the detection model descriptions of their respective security products using a large language model (LLM).

FIG. 17 is a diagram for explaining a specific example of calculating, using a large language model, the similarity between detection model descriptions used by security products, according to the embodiment.

As shown in FIG. 17, for example, the following method is possible: a query is made about the similarity between two target detection model descriptions after any two detection model descriptions and the similarity between these detection model descriptions are explicitly given to a large language model. The similarity-between-alerts calculator according to Variation 2 calculates the similarity between the alerts in such a manner. In particular, the similarity-between-alerts calculator according to Variation 2 inputs two target detection model descriptions after giving an example of two detection model descriptions and the similarity between these detection model descriptions to the prompt of the large language model, and obtains the similarity between the two target detection model descriptions as the answer to this input. More specifically, the similarity-between-alerts calculator according to Variation 2 calculates the similarity between the alerts by inputting the detection model description included in the alert generated from each of security products 300a and 300b, into the large language model trained using any two detection model descriptions and the similarity between these two detection model descriptions, and by obtaining the similarity between the detection model descriptions which is outputted from the large language model. The similarity-between-alerts calculator according to Variation 2 is one example of the similarity calculator.

It is to be noted that the pair of the detection model descriptions inputted as an example here may comprise multiple pairs.

Moreover, for example, a method of performing Fine-tuning using training data may be used such that the similarity between two detection model descriptions is calculated using the method disclosed in FIG. 1 of NPL 1 mentioned above. In other words, Fine-tuning in machine learning may be applied to the large language model used by the similarity-between-alerts calculator according to Variation 2.

### (Advantageous Effects, etc.)

Hereinafter, techniques obtained from the disclosure of this specification are illustrated by an example, and the advantageous effects, etc. obtained from these techniques are described.

Technique 1 is a security monitoring device including: a receiver that receives a first alert generated by a first security product detecting a threat and a second alert generated by a second security product detecting a threat, the second security product being different from the first security product; a similarity calculator that calculates a similarity between the first alert and the second alert; and a first determiner that determines whether the first alert and the second alert are alerts generated by detecting a same threat, based on the similarity between the first alert and the second alert.

The first security product is, for example, security product 300a, and the second security product is, for example, security product 300b. The receiver is, for example, alert-to-be-determined receiver 101. The similarity calculator is, for example, similarity-between-alerts calculator (similarity-between-alerts calculator 105, 205, 305, or the like). The first determiner is, for example, same-threat-alert determiner 104. The security monitoring device is, for example, same-threat-alert identifying unit (same-threat-alert identifying unit 100, 1000, 2000, or the like). The second alert is, for example, an alert detected by the second security product and received before the first alert by the receiver.

With the security monitoring device according to one aspect of the present disclosure, based on the similarities of alerts generated by multiple security products detecting their respective threats, it is possible to determine whether the alerts are alerts generated by detecting the same threat. Accordingly, for example, the security monitoring device can output information indicating whether the alerts are alerts generated by detecting the same threat, to a device for analyzing the detected threats that have caused the alerts. With this, for example, for the same threat, the device can efficiently perform an analysis based on this information, and thus the threats that have caused the alerts can be efficiently analyzed. In other words, this device can reduce the processing amount of the analysis based on this information. Accordingly, with the security monitoring device according to one aspect of the present disclosure, the threats that have caused the alerts can be efficiently analyzed.

Technique 2 is the security monitoring device according to technique 1, in which the first alert includes a first detection model description describing the threat detected by the first security product, the second alert includes a second detection model description describing the threat detected by the second security product, and the similarity calculator calculates the similarity between the first alert and the second alert based on a term frequency (TF)-inverse document frequency (IDF) vector of the first detection model description and a TF-IDF vector of the second detection model description, each of the TF-IDF vectors being calculated using IDF values of words included in document information indicating a document on security.

The similarity calculator described here is, for example, similarity-between-alerts calculator 105.

With this, the similarity between the alerts can be accurately calculated.

Technique 3 is the security monitoring device according to technique 1 or 2, in which the first alert includes a first detection model description describing the threat detected by the first security product, the second alert includes a second detection model description describing the threat detected by the second security product, and the similarity calculator calculates the similarity between the first alert and the second alert by extracting one or more words of interest included in the first detection model description and one or more words of interest included in the second detection model description using a predefined word-of-interest list, and by calculating a similarity between a first word-of-interest group and a second word-of-interest group, the first word-of-interest group being of one or more words of interest extracted from the first detection model description, the second word-of-interest group being of one or more words of interest extracted from the second detection model description.

The similarity calculator described here is, for example, similarity-between-alerts calculator according to Variation 1.

With this, the similarity between the alerts can be accurately calculated.

Technique 4 is the security monitoring device according to any of techniques 1 to 3, in which the first alert includes a first detection model description describing the threat detected by the first security product, the second alert includes a second detection model description describing the threat detected by the second security product, and the similarity calculator calculates the similarity between the first alert and the second alert based on a vector of the first detection model description and a vector of the second detection model description, each of the vectors indicating matching degrees of threat classification categories and being calculated using an attack classification model trained using threat intelligence information indicating both classification information indicating one or more threat classification categories and a content of the one or more threat classification categories.

The similarity calculator described here is, for example, similarity-between-alerts calculator 205. Moreover, the vector described here is, for example, the attack vector described above.

With this, the similarity between the alerts can be accurately calculated.

Technique 5 is the security monitoring device according to any of techniques 1 to 4, in which the first alert includes a first detection model description describing the threat detected by the first security product, the second alert includes a second detection model description describing the threat detected by the second security product, and the similarity calculator calculates the similarity between the first alert and the second alert by calculating a similarity between the first detection model description and the second detection model description using a feature extracted from first detection information and a feature extracted from second detection information, the first detection information indicating previous attack detection results in the first security product, the second detection information indicating previous attack detection results in the second security product.

The similarity calculator described here is, for example, similarity-between-alerts calculator 305.

With this, the similarity between the alerts can be easily calculated.

Technique 6 is the security monitoring device according to any one of techniques 1 to 5, further including: a second determiner that determines whether the first alert and the second alert are each an alert generated by detecting a same threat, based on product information on the first security product and product information on the second security product.

The second determiner is, for example, obvious same-threat-alert determiner 103. Moreover, the product information is, for example, information indicating what kind of threat the detection model, using which the security product detects a threat, detects. For example, the product information is information indicating malware detection, etc. For example, when both the first security product and the second security product detect only a malware, the second determiner determines that the first alert and the second alert are alerts generated by detecting the same threat. On the other hand, for example, when the first security product and the second security product detect at least one different threat, the second determiner determines that the first alert and the second alert are not alerts generated by detecting the same threat. The determination result of the second determiner is outputted to, for example, the first determiner. The product information may be stored in advance in the memory included in the security monitoring device, or may be transmitted from the security product to the security monitoring device.

With this, even when the number of alerts received by the receiver is enormous, whether to be alerts generated by detecting the obviously same threat can be determined by the second determiner. Accordingly, the number of alerts to be determined by the first determiner can be reduced, and thus it is possible to reduce the processing amount of the security monitoring device.

Technique 7 is the security monitoring device according to any of techniques 1 to 6, further including: an extractor that extracts candidate alerts from among alerts received by the receiver, based on a predetermined condition, in which the similarity calculator calculates the similarity between the first alert and the second alert which are included in the candidate alerts extracted.

The extractor is, for example, same-threat-alert candidate extractor 102. The predetermined condition is, for example, the foregoing condition of narrowing down candidate alerts, i.e., a difference in the occurrence time between the alert notified by security product 300a and the alert notified by security product 300b is within 60 minutes, and/or the IP address of the device detected as a threat is the same. The extractor outputs information indicating the extracted candidate alerts to, for example, the first determiner and/or the second determiner. For example, the first determiner and/or the second determiner perform the determination described above on, for example, the candidate alerts extracted by the extractor.

With this, the number of alerts to be determined by the first determiner and/or the second determiner can be reduced, and thus it is possible to reduce the processing amount of the security monitoring device.

Technique 8 is the security monitoring device according to any of techniques 1 to 6, in which the first alert includes a first detection model description describing the threat detected by the first security product, the second alert includes a second detection model description describing the threat detected by the second security product, and the similarity calculator calculates the similarity between the first alert and the second alert by inputting the first detection model description and the second detection model description into a large language model trained using two detection model descriptions and a similarity between the two detection model descriptions, and by obtaining a similarity between the first detection model description and the second detection model description which is outputted from the large language model.

The similarity calculator described here is, for example, similarity-between-alerts calculator 305.

With this, the similarity between the alerts can be easily calculated.

Technique 9 is the security monitoring device according to technique 8, in which Fine-tuning in machine learning is applied to the large language model.

With this, the similarity between the alerts can be accurately calculated.

Technique 10 is a security monitoring method, including: receiving a first alert generated by a first security product detecting a threat and a second alert generated by a second security product detecting a threat, the second security product being different from the first security product; calculating a similarity between the first alert and the second alert; and determining whether the first alert and the second alert are alerts generated by detecting a same threat, based on the similarity between the first alert and the second alert.

In this manner, the effects similar to those of the security monitoring device according to one aspect of the present disclosure are produced.

Technique 11 is a program for causing a computer to execute the security monitoring method according to technique 10.

With this, the effects similar to those of the security monitoring device according to one aspect of the present disclosure are produced.

### (Complements)

As described above, the embodiment has been described as an example of the technique disclosed in the present application. However, the technique according to the present disclosure is not limited to this embodiment, and may be applied to other embodiments on which various changes, replacement, addition, omission, and the like are performed appropriately.

Variations of the embodiment in the present disclosure are listed below.

(1) In the embodiment, the security product is not necessarily a device that monitors only packet information inputted from L2SW mirror port. For example, the security product may be a monitoring device that monitors, for example, logs of firewalls, proxies, general-purpose computers, or various production devices. The types of logs to be monitored are not constrained.

(2) In the embodiment, the method of calculating the similarity between the detection model descriptions using TF-IDF, and the combination of the method of calculating the similarity between the descriptions using the attack technique classification information and the method of calculating the similarity between the detection models using the alert-occurrence-tendency vector are described, but either of them is not necessarily used. For example, only one of the similarity calculation methods described above may be used, or a combination with any method including the method of calculating the similarity between the descriptions using the words of interest is also possible. Moreover, it is not even necessary to individually use each of the similarity calculation methods. The vectors calculated using these methods are concatenated into one vector, and the similarity between the vectors generated in this manner may be used.

(3) In the embodiment, components in the security monitoring device may be individually configured into a single chip using a semiconductor device such as an integrated circuit (IC), or a large scale integration (LSI) circuit, or may be partially or entirely configured into a single chip. Moreover, the method of circuit integration is not limited to LSIs, and implementation through a dedicated circuit or a general-purpose processor is also possible. A field programmable gate array (FPGA) which allows programming after LSI manufacturing or a reconfigurable processor which allows reconfiguration of the connections or settings of the circuit cells inside the LSI may also be used. Furthermore, depending on the emergence of circuit integration technology that replaces LSI due to progress in semiconductor technology or other derivative technology, it is obvious that such technology may be used to integrate the function blocks. Possibilities in this regard include the application of biotechnology and the like.

(4) The same-threat-alert identifying unit is implemented by, for example, a computer. The computer includes, for example, a communication interface for communicating with each device such as the security product and configured by a connector or a wireless communication circuit connected to a communication line, a non-volatile memory storing a program, a volatile memory which is a temporary storage area for executing a program, a storage storing each information, an input and output port for transmitting and receiving a signal, a processor that executes a program, and the like. This computer may be implemented as a so-called microcomputer. Same-threat-alert identifying unit according to the embodiment is, for example, one example of the security monitoring device.

(5) In the foregoing embodiment, the process to be executed by a specific processing unit such as the similarity calculator and the same-threat-alert determiner may be executed by another processing unit. Moreover, the order of the processes may be changed, or the processes may be performed in parallel.

(6) In the foregoing embodiment, each component (each processing unit) may be implemented by executing a software program suitable for each component. Each component may be implemented by a program executer, such as a central processing unit (CPU) or a processor, reading out and executing a software program recorded on a recording medium such as a hard disk or a semiconductor memory. Each component may be implemented by hardware. Each component may be a circuit (or an integrated circuit). These circuits may be configured into one circuit as a whole, or may be separate circuits. Moreover, each of the circuits may be a general-purpose circuit or a dedicated circuit.

(7) The general or specific aspect of the present disclosure may be implemented by a system, a device, a method, an integrated circuit, a computer program, or a non-transitory recording medium such as a computer-readable CD-ROM. For example, the present disclosure may be implemented as a program for causing a computer to execute the security monitoring method for the security monitoring device according to the embodiment. Moreover, the present disclosure may be implemented by any combination of systems, devices, methods, integrated circuits, computer programs, and recording media.

Although only some exemplary embodiments of the present disclosure have been described in detail above, those skilled in the art will readily appreciate that many modifications are possible in the exemplary embodiments without materially departing from the novel teachings and advantages of the present disclosure. Accordingly, all such modifications are intended to be included within the scope of the present disclosure.

### INDUSTRIAL APPLICABILITY

The present disclosure is useful for a technique for aggregating alerts generated from security products.

1. A security monitoring device, comprising:
a receiver that receives a first alert generated by a first security product detecting a threat and a second alert generated by a second security product detecting a threat, the second security product being different from the first security product;
a similarity calculator that calculates a similarity between the first alert and the second alert; and
a first determiner that determines whether the first alert and the second alert are alerts generated by detecting a same threat, based on the similarity between the first alert and the second alert.

2. The security monitoring device according to claim 1, wherein
the first alert includes a first detection model description describing the threat detected by the first security product,
the second alert includes a second detection model description describing the threat detected by the second security product, and
the similarity calculator calculates the similarity between the first alert and the second alert based on a term frequency (TF)-inverse document frequency (IDF) vector of the first detection model description and a TF-IDF vector of the second detection model description, each of the TF-IDF vectors being calculated using IDF values of words included in document information indicating a document on security.

3. The security monitoring device according to claim 1, wherein
the first alert includes a first detection model description describing the threat detected by the first security product,
the second alert includes a second detection model description describing the threat detected by the second security product, and
the similarity calculator calculates the similarity between the first alert and the second alert by extracting one or more words of interest included in the first detection model description and one or more words of interest included in the second detection model description using a predefined word-of-interest list, and by calculating a similarity between a first word-of-interest group and a second word-of-interest group, the first word-of-interest group being of one or more words of interest extracted from the first detection model description, the second word-of-interest group being of one or more words of interest extracted from the second detection model description.

4. The security monitoring device according to claim 1, wherein
the first alert includes a first detection model description describing the threat detected by the first security product,
the second alert includes a second detection model description describing the threat detected by the second security product, and
the similarity calculator calculates the similarity between the first alert and the second alert based on a vector of the first detection model description and a vector of the second detection model description, each of the vectors indicating matching degrees of threat classification categories and being calculated using an attack classification model trained using threat intelligence information indicating both classification information indicating one or more threat classification categories and a content of the one or more threat classification categories.

5. The security monitoring device according to claim 1, wherein
the first alert includes a first detection model description describing the threat detected by the first security product,
the second alert includes a second detection model description describing the threat detected by the second security product, and
the similarity calculator calculates the similarity between the first alert and the second alert by calculating a similarity between the first detection model description and the second detection model description using a feature extracted from first detection information and a feature extracted from second detection information, the first detection information indicating previous attack detection results in the first security product, the second detection information indicating previous attack detection results in the second security product.

6. The security monitoring device according to claim 1, further comprising:
a second determiner that determines whether the first alert and the second alert are each an alert generated by detecting a same threat, based on product information on the first security product and product information on the second security product.

7. The security monitoring device according to claim 1, further comprising:
an extractor that extracts candidate alerts from among alerts received by the receiver, based on a predetermined condition, wherein
the similarity calculator calculates the similarity between the first alert and the second alert which are included in the candidate alerts extracted.

8. The security monitoring device according to claim 1, wherein
the first alert includes a first detection model description describing the threat detected by the first security product,
the second alert includes a second detection model description describing the threat detected by the second security product, and
the similarity calculator calculates the similarity between the first alert and the second alert by inputting the first detection model description and the second detection model description into a large language model trained using two detection model descriptions and a similarity between the two detection model descriptions, and by obtaining a similarity between the first detection model description and the second detection model description which is outputted from the large language model.

9. The security monitoring device according to claim 8, wherein
Fine-tuning in machine learning is applied to the large language model.

10. A security monitoring method, comprising:
receiving a first alert generated by a first security product detecting a threat and a second alert generated by a second security product detecting a threat, the second security product being different from the first security product;
calculating a similarity between the first alert and the second alert; and
determining whether the first alert and the second alert are alerts generated by detecting a same threat, based on the similarity between the first alert and the second alert.

11. A non-transitory computer-readable recording medium storing a program for causing a computer to execute the security monitoring method according to claim 10.
